(19) United States
(12) Patent Application Publication
(10) Pub. No.: US 2008/0186998 A1
(43) Pub. Date: Aug. 7, 2008

(54) Network-On-Chip Environment and Method for Reduction of Latency

(75) Inventor: Edwin Rijpkema, Nieuwerkerk a/d ljssel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/910,749

(22) PCT Filed: Apr. 4, 2006
(86) PCT No.: PCT/IB06/51012

§ 371 Date: Oct. 5, 2007

(30) Foreign Application Priority Data
Apr. 6, 2005 (EP) 05102702.7

(51) Int. Cl. H04L 12/43

(52) U.S. Cl. 370/458

(57) ABSTRACT

The invention relates to an integrated circuit comprising a plurality of processing modules (IP) and a network (NoC) arranged for coupling processing modules (IP), comprising: the processing module (IP) includes an associated network interface (NI) which is provided for transmitting data to the network (NoC) supplied by the associated processing module and for receiving data from the network (NoC) destined for the associated processing module, wherein the data transmission between processing modules (IP) operates based on time division multiple access (TDMA) using time slots (S) and contention free transmission by using channels (a-d); each network interface (NI) includes a slot table (ST) for storing an allocation of a time slot to a certain channel (a-d), wherein at least a part of the time slots (0-9) allocated to channels (a-d) originated from the same network interface (NI) are shared for transmission of data of the set of channels (a-d). The invention uses the idea to utilize all or at least a part of slots of channels (a-d) in common, which are originating from the same network interface (NI). This will at first reduce the latency of such channels (a-d). Additionally the sizes of the slot tables (ST) in all network components (NI, R1 1-R44) are reduced drastically.

The invention relates to an integrated circuit having a plurality of processing modules and a network arranged for coupling processing modules and a method for time slot allocation in such an integrated circuit, and a data processing system.

Systems on silicon show a continuous increase in complexity due to the ever increasing need for implementing new features and improvements of existing functions. This is enabled by the increasing density with which components can be integrated on an integrated circuit. At the same time the clock speed at which circuits are operated tends to increase too. The higher clock speed in combination with the increased density of components has reduced the area which can operate synchronously within the same clock domain. This has created the need for a modular approach. According to such an approach a processing system comprises a plurality of relatively independent, complex modules. In conventional processing systems the modules usually communicate to each other via a bus. As the number of modules increases however, this way of communication is no longer practical for the following reasons. A large number of modules represent a high bus load. Further the bus represents a communication bottleneck as it enables only one module to send data to the bus.

A communication network forms an effective way to overcome these disadvantages.

Networks on chip (NoC) have received considerable attention recently as a solution to the interconnection problem in highly-complex chips. The reason is twofold. First, NoCs help resolve the electrical problems in new deep-submicron technologies, as they structure and manage global wires. At the same time the NoC concept share wires, allows a reduction of the number of wires and increases the utilization of wires. NoCs can also be energy efficient and reliable and are scalable compared to buses. Second, NoCs also decouple computation from communication, which is essential in managing the design of billion-transistor chips. NoCs achieve this decoupling because they are traditionally designed using protocol stacks, which provide well- defined interfaces separating communication service usage from service implementation.

Introducing networks as on-chip interconnects radically changes the communication when compared to direct interconnects, such as buses or switches. This is because of the multi-hop nature of a network, where communication modules are not directly connected, but are remotely separated by one or more network nodes. This is in contrast with the prevalent existing interconnects (i.e., buses) where modules are directly connected. The implications of this change reside in the arbitration (which must change from centralized to distributed), and in the communication properties (e.g., ordering, or flow control), which must be handled either by an intellectual property block (IP) or by the network.

Most of these topics have been already the subject of research in the field of local and wide area networks (computer networks) and as an interconnect for parallel processor networks. Both are very much related to on-chip networks, and many of the results in those fields are also applicable on chip. However, NoC's premises are different from off-chip networks, and, therefore, most of the network design choices must be reevaluated. On-chip networks have different properties (e.g., tighter link synchronization) and resource constraints (e.g., higher memory cost) leading to different design choices, which ultimately affect the network services. Storage (i.e., memory) and computation resources are relatively more expensive, whereas the number of point-to-point links is larger on chip than off chip. Storage is expensive, because general-purpose on-chip memory, such as RAMs, occupies a large area. Having the memory distributed in the network components in relatively small sizes is even worse, as the overhead area in the memory then becomes dominant.

A network on chip (NoC) typically consists of a plurality of routers and network interfaces. Routers serve as network nodes and are used to transport data from a source network interface to a destination network interface by routing data on a correct path to the destination on a static basis (i.e., route is predetermined and does not change), or on a dynamic basis (i.e., route can change depending e.g., on the NoC load to avoid hot spots). Routers can also implement time guarantees (e.g., rate-based, deadline-based, or using pipelined circuits in a TDMA fashion). A known example for NoCs is AEthereal.

The network interfaces are connected to processing modules, also called IP blocks, which may represent any kind of data processing unit, a memory, a bridge, a compressor etc. In particular, the network interfaces constitute a communication interface between the processing modules and the network. The interface is usually compatible with the existing bus interfaces. Accordingly, the network interfaces are designed to handle data sequentialization (fitting the offered command, flags, address, and data on a fixed-width (e.g., 32 bits) signal group) and packetization (adding the packet headers and trailers needed internally by the network). The network interfaces may also implement packet scheduling, which may include timing guarantees and admission control.

An NoC provides various services to processing modules to transfer data between them.

The NoC could be operated according to best effort (BE) or guaranteed throughput (GT) services. In best effort (BE) service, there are no guarantees about latency or throughput. Data is forwarded through routers without any reservation of slots. So this kind of data faces contention in the router, whereas giving guarantees is not possible. In contrast, GT service allows deriving exact value for latency and throughput for transmitting data between processing modules.

On-chip systems often require timing guarantees for their interconnect communications. A cost-effective way of providing time-related guarantees (i.e., throughput, latency and jitter) is to use pipelined circuits in a TDMA (Time Division Multiple Access) fashion, which is advantageous as it requires less buffer space compared to rate-based and deadline-based schemes on systems on chip (SoC) which have tight synchronization. Therefore, a class of communication is provided, in which throughput, latency and jitter are guaranteed, based on a notion of global time (i.e., a notion of synchronicity between network components, i.e. routers and network interfaces), wherein the basic time unit is called a slot or time slot. All network components usually comprise a slot table of equal size for each output port of the network component, in which time slots are reserved for different connections.

At the transport layer of the network, the communication between the processing modules is performed over connections. A connection is considered as a set of channels, each having a set of connection properties, between a first processing module and at least one second processing module. For a connection between a first processing module and a single second processing module, the connection may comprises two channels, namely one from the first to the second processing module, i.e. the request or forward channel, and a second channel from the second to the first processing module, i.e. the response or reverse channel. The forward or request channel is reserved for data and messages from the master to the slave, while the reverse or response channel is reserved for data and messages from the slave to the master. If no response is required, the connection may only comprise one channel. It is not illustrated but possible, that the connection involves one master and N slaves. In that case 2*N channels are provided. Therefore, a connection or the path of the connection through the network comprises at least one channel. In other words, a channel corresponds to the connection path of the connection if only one channel is used. If two channels are used as mentioned above, one channel will provide the connection path e.g. from the master to the slave, while the second channel will provide the connection path from the slave to the master. Accordingly, for a typical connection, the connection path will comprise two channels. The connection properties may include ordering (data transport in order), flow control (a remote buffer is reserved for a connection, and a data producer will be allowed to send data only when it is guaranteed that buffer space is available for the produced data), throughput (a lower bound on throughput is guaranteed), latency (upper bound for latency is guaranteed), the lossiness (dropping of data), transmission termination, transaction completion, data correctness, priority, or data delivery. In NoC, connections are built on top channels. A channel is a unidirectional path through the network from a source (master, initiator) to a destination (slave, target) or back.

For implementing GT services slot tables are used. The slot tables as mentioned above are stored in the network components, including network interfaces and routers. The slot tables allow a sharing of the same link or wires in a time-division multiple access, TDMA, manner. The quantum of data that is injected into the network is called a flit, wherein a flit is a fixed size sub-packet. The injection of flits is regulated by the slot table stored in the network interface. The slot table advances in synchronization (i.e., all are in the same slot at the same time). A channel may have one or more slots allocated within a slot table. The slot tables in all network components are so filled that flits communicated over the network do not content. The channels are used to identify different traffic classes and associate properties to them. At each slot, a data item is moved from one network component to the next one, i.e. between routers or between a router and a network interface. Therefore, when a slot is reserved at an output port, the next slot must be reserved on the following output port along the path between a master and a slave module, and so on. When multiple connections are set up between several processing modules with timing guarantees, the slot allocation must be performed such that there are no clashes (i.e., there is no slot allocated to more than one connection). The slots must be reserved in such a way that data never has to contend with any other data. It is also called as contention free routing.

The task of finding an optimum slot allocation for a given network topology i.e. a given number of routers and network interfaces, and a set of connections between processing modules is a highly computational-intensive problem as it involves finding an optimal solution which requires exhaustive computation time.

An important feature for transmission of data between processing modules is the latency. A general definition of latency in networking could be summarized as the amount of time it takes a data packet to travel from source to destination. Together, latency and bandwidth define the speed and capacity of a network. The latency to access data depends on the size of such a slot table, assignment of slots for a given channel in the table and the burst size. The burst size is the amount of data that can be asked/sent in one request. When the number of slots allocated to a channel is less than the number of slots required to transfer a burst of data the latency to access data increases dramatically. In such case more than one revolution of the slot table is needed to completely send a burst of data. The waiting time for the slots that are not allocated to this connection is also added to the latency.

The network interfaces contain conventionally a queue per channel. The waiting time in that queue turns out to be the major contribution to the total communication latency. The larger the slot table in number of slots and the fewer slots are reserved for a channel, the higher the waiting latency.

The other problem is that when a single processing module requires many channels, say n, then the slot table requires at least n slots, one for each channel. However, this is not practical in general because the bandwidth requirements of the various channels may differ significantly which require even larger slot tables to allocate bandwidth at a finer granularity. The cost of the slot tables and thus of the network interfaces and thus of the network as a whole highly depends on the number of slots in the slot tables.

Therefore it is an object of the present invention is to provide an arrangement and a method having an improved slot allocation in a Network on Chip environment.

This object is solved by an integrated circuit according to claim 1 and to a method for time slot allocation according to claim 7.

It is proposed to share slots of channels having their origin at the same network interface. At least a part of the slots allocated to channels originating from the same network interface are shared. So a pool of slots is formed, which could be used by all channels together.

They will drastically reduce the latency. In particular the latency of channels having only a small number of slots allocated will be reduced. Since the number of slots in the slot table could be reduced by the sharing the memory space requirements in all network components are reduced.

Other aspects and advantages of the invention are defined in the dependent claims.

In a preferred embodiment of the invention all slots allocated to channels originating from the same network interface are shared. This will simplify the control of data transmission of the channels having shared slots.

In a further predetermined embodiment of the invention there is channel scheduler included in the network interface, the scheduler is provided for scheduling the data of the set of channels to the shared slots.

In a further predetermined embodiment of the invention the data of a channel are scheduled by the scheduler depending on the position in a queue. The control of the data transmission could be achieved by queuing the data belonging to set of channels in only one queue. Thus a first come first serve policy is implemented. This will further reduce the chip area required for the input queue in the network interface. Conventionally there is one queue per channel. According to the present invention it is advantageously to input all data of the shared channels in only one queue. The scheduler needs to schedule the data depending on its position in the queue.

In a preferred embodiment of the invention a scheduling of data of the set of channel is performed depending the filling status of the queue of the set of the channels. In an embodiment having a queue for each channels the scheduler will monitor the filling status of the queues of the channels. The first queue not being empty will be scheduled to be transferred. Then the scheduler will monitor the queues from that scheduled queue, wherein only queues are scheduled being not empty.

The invention also relates to a method for allocating time slots for data transmission in an integrated circuit having a plurality of processing modules and a network arranged for coupling the processing modules, and a plurality of network interfaces each being coupled between one of the processing modules and the network comprising the steps of: communicating between processing modules based on time division multiple access using time slots and contention free transmission by using channels; storing a slot table in each network interface including an allocation of a time slot to a certain channel, sharing of time slots allocated to channels originating from the same network interface.

The invention further relates to a data processing system comprising: a plurality of processing modules and a network arranged for coupling the processing modules, comprising: a network interface associated to each processing module which is provided for transmitting data to the network supplied by the associated processing module and for receiving data from the network destined for the associated processing module; wherein the data transmission between processing modules operates based on time division multiple access using time slots and contention free transmission by using a channels; each network interface includes a slot table for storing an allocation of a time slot to a certain channel, a sharing is provided of time slots allocated to channels originating from the same network interface.

Accordingly, the time slot allocation may also be performed in a multi-chip network or a system or network with several separate integrated circuits.

Preferred embodiments of the invention are described in detail below, by way of example only, with reference to the following schematic drawings.

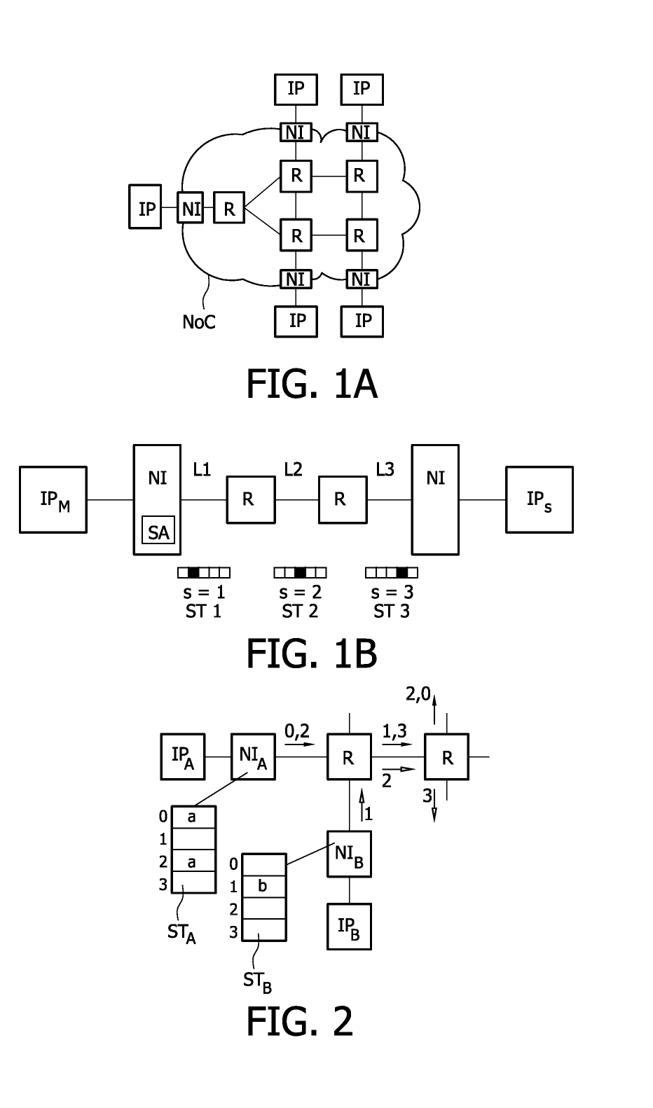

FIG. 1A shows the basic structure of a network on chip according to the invention;

FIG. 1B shows a basic slot allocation for a channel in a NoC;

FIG. 2 illustrates a schematic structure for illustrating the contention free routing;

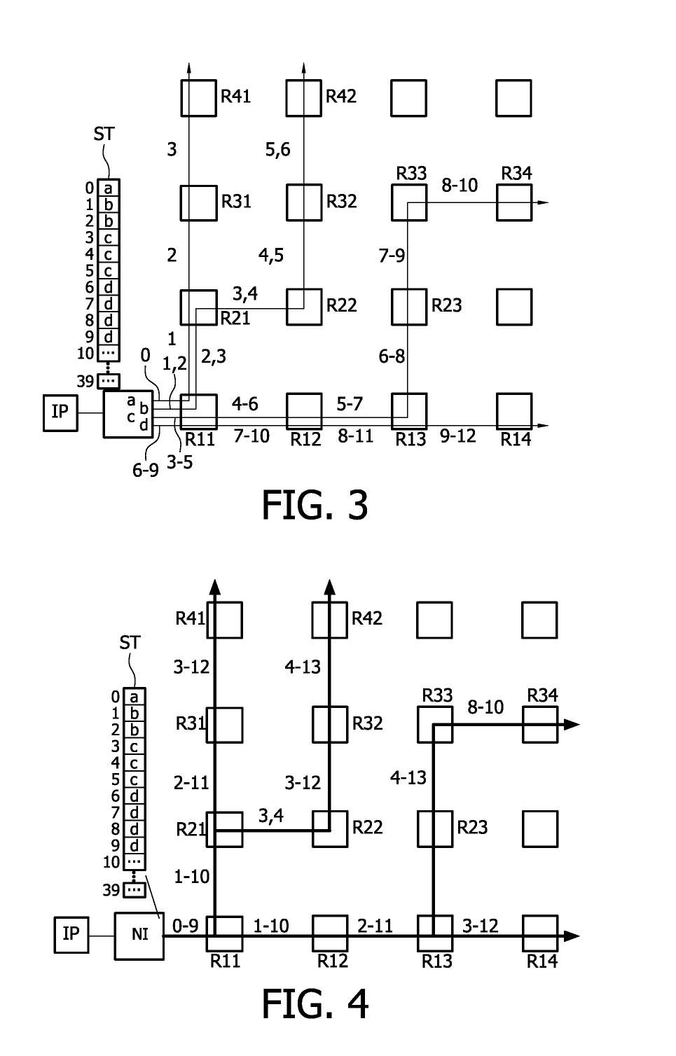

FIG. 3 shows a schematic illustration of a network provided with a conventional slot allocation for channels;

FIG. 4 shows the slot allocation according to the present invention;

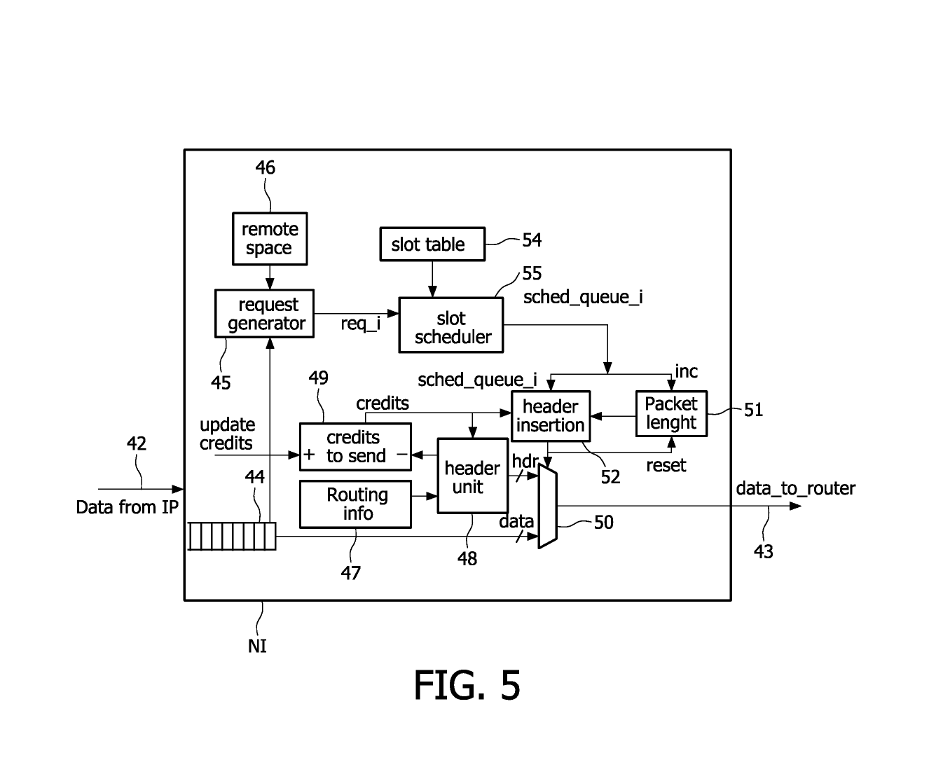

FIG. 5 illustrates a network interface according to the present invention;

The drawings are provided for illustrative purpose only and do not necessarily represent practical examples of the present invention to scale.

In the following the various exemplary embodiments of the invention are described.

Although the present invention is applicable in a broad variety of applications it will be described with the focus put on NoC, especially to AEthereal design. A further field for applying the invention might each NoC providing guaranteed services by using time slots and slot tables.

In the following the general architecture of a NoC will be described referring to FIGS. 1A, 1B and 2.

The embodiments relate to systems on chip SoC, i.e. a plurality of processing modules IP on the same chip communicate with each other via some kind of interconnect. The interconnect is embodied as a network on chip NoC. The network on chip NoC may include wires, bus, time-division multiplexing, switch, and/or routers within a network.

FIG. 1A shows an example for an integrated circuit having a network on chip NoC according to the present invention. The system comprises several processing modules IP, also called IP blocks. The processing modules IP could be realized as computation elements, memories or a subsystem which may internally contain interconnect modules. The processing modules IP are each connected to a network NoC via a network interface NI, respectively. The network NoC comprises a plurality of routers R, which are connected to adjacent routers R via respective links L1, L2, L3. The network interfaces NI are used as interfaces between the processing modules IP and the network NoC. The network interfaces NI are provided to manage the communication of the respective processing modules IP and the network NoC, so that the processing modules IP can perform their dedicated operation without having to deal with the communication with the network NoC or other processing modules IP. The processing modules IP may act as masters IP_{M}, i.e. initiating a request, or may act as slaves IP_{S}, i.e. receiving a request from a master IP_{M} and processing the request accordingly.

FIG. 1B shows a block diagram of a single connection having one channel and a respective basic slot allocation in a network on chip NoC. In particular, the channel between a master IP_{M} and a slave IP_{S} is shown. This connection path is realized by a network interface NI associated to the master IPM, two routers, and a network interface NI associated to a slave IP_{S}. The network interface NI associated to the master IP_{M} comprises a time slot allocation unit SA. Alternatively, the network interface NI associated to the slave IP_{S} may also comprise a time slot allocation unit SA. A first link L1 is present between the network interface NI associated to the master IP_{M} and a first router R, a second link L2 is present between the two routers R, and a third link L3 is present between a router R and the network interface NI associated to the slave IP_{S}. Three slot tables ST1-ST3 for the output ports of the respective network components NI, R, R are also shown. These slot tables ST are preferably implemented on the output side, i.e. the data producing side, of the network elements NI, R, R. For each requested slot s, one slot s is reserved in each slot table ST of the links along the connection path. All these slots s must be free, i.e., not reserved by other channels. Since the data advance from one network component to another each slot, starting from slot s=1, the next slot along the connection must be reserved at slot s=2 and then at slot s=3. The inputs for the slot allocation determination performed by the time slot allocation unit SA are the network topology, like network components, with their interconnection, and the slot table size, and the connection set. For every connection, its paths and its bandwidth, latency, jitter, and/or slot requirements are given. Each of these channels is set on an individual path, and may comprise different links having different bandwidth, latency, jitter, and/or slot requirements. To provide time related guarantees, slots must be reserved for the links as shown in FIG. 1B. Different slots can be reserved for different connections or channels by means of TDMA. Data for a connection is then transferred over consecutive links along the connection in consecutive slots.

FIG. 2 illustrates a more detailed example for a contention free routing. There are only two processing modules IP_{A} and IP_{B}. Each processing modules IP_{A} and IP_{B} is transmitting data using different channels. The processing modules IP_{A} and IP_{B} are connected via their respective network interfaces NI_{A} and NI_{B} to the NoC represented by the two routers R. Each of the network interfaces NI_{A} and NI_{B} includes a slot table ST_{A} and ST_{B}. Channel a for processing module IP_{A} has two slots 0, 2 allocated in the slot table ST_{A}. Channel b for IP_{B} has one slot 1 allocated. The paths for channel a and b are indicated by the solid and open headed arrows, respectively. The slots s are reserved in such a way that flits do not content in the network. This is indicated by the numbers denoted next to the arrows. They represent the slots s at which the links are reserved. This will be explained in detail for the path of the flits transmitted by processing module IP_{A}. At slot 0 and 2 the link between the network interface NI_{A} and the first router R is reserved for the flits for channel a. For the next step the link between the two routers R is reserved during slot 1 and 3 for data from processing module IP_{A}. During slot 2 that link is reserved for channel b. Since a slot table ST has only four positions for allocating slots s to channels a, b. The slots 2 and 0 are reserved for channel a for the outgoing flits from the right side router R. In the not shown slot table of that right side router R slot 3 is reserved for channel 3. This shows that no positions in the slot tables ST are allocated that flits will content. By this procedure a guaranteed throughput could be provided. However the small example illustrates also the difficulties or effort for allocating the slots s to channels a, b throughout the NoC.

The underlying problem of high latency will be illustrated referring to FIG. 3 showing an exemplary network. Due to the sake of clarity only one IP and the associated network interface NI are shown. The remaining boxes represent routers R11-R44 of the NoC, wherein only the routers having traffic are designated respectively. The processing module IP needs four channels a, b, c, and d. The 4×4 mesh represents the network NoC including the routers R11-R44. The links between the routers R11-R44 are not drawn for clarity. The slot table ST of the network interface NI of the processing module IP includes 40 slots. The worst case waiting time at the head of the queue for channel a is the duration of 39 slots. Each channel a, b, c and d require a bandwidth requirement of 1/40, 2/40, 3/40 and 4/40 of the bandwidth capacity of the links, respectively. Because bandwidth allocation is done at a granularity of 1/40 of the link bandwidth, the slot table ST requires at least 40 slots. As channel a has only 1 of the 40 slots, the worst case waiting time for a flit at the head of the queue for channel a in the network interface NI is the duration of 39 slots. When flits are injected into the network, the latency is the number of hops in the router network multiplied by the duration of a slot. For a large NoC the maximum number of hops is 20. This means that for a small slot-table the worst case waiting time for this small example already is dominant. The numbers nearby the arrows of the respective channels a-d indicate slot positions in the slot tables which need to be reserved in the respective slot table of the outputting network component (NI or router). The allocation of slots to the respective channels a-d between NI and R11 could be derived from the slot table ST. For channels c and d the slots 4-6 and 7-10 are reserved between R11 und R12. Between R12 and R13 slots 5-7 are reserved for channel c and slots 8-11 are reserved for channel d. Between R11 and R21 the slot 1 is reserved for channel a and the slots 2, 3 are reserved for channel b etc.

In the following the present invention will be explained referring to FIG. 4. The solution that is proposed here is to allocate bandwidth for a set of channels a-d originating from the same NI. Instead of reserving a slot for each of those channels a-d individually, slots are reserved for the whole set of channels a-d. So, each of the channels a, b, c, or d, may access the network in slots 0 . . . 9. A local arbitration mechanism is required when more than one of these channels a-d want to access the same slot. This is explained below.

The ten slots 0-9 allocated to the set are now designated by S. The ten slots S can be redistributed in the slot table ST. A good redistribution will place these slots S at equal distances in the slot table ST with possibly a minor over allocation of slots. This means that the ten slots S are located at slots 0, 4, 8, . . . , 36. However this distribution not only minimizes the worst case waiting time for a slot, but also allows to reduce the size of slot table by a factor of ten. This will cause a strong reduction of memory space required for the slot tables in each of the participating network components NI, R11-R44, etc. The reduced slot table ST has four slots only, and one of these slots 0-3 is assigned to channel set. A complete traversal of the small slot table is thus four slots, and the slot for channel set is thus available every four slots, which is the same as the example in which the ten slots were nicely distributed over the forty slots. Since all channels outgoing from the network interface NI are combined in that channel set, the rest of the slots in the slot table are used for channels not outgoing from the respective network interface NI.

When multiple channels a-d are combined into a channel set, some mechanism is required to schedule the data sequentially onto the network. There are basically two approaches for that. However before explaining the mechanism for scheduling the data of the multiple channels the structure of a network interface NI will be explained referring to FIG. 5.

FIG. 5 illustrates the components of a network interface NI. However, only the transmitting direction of the NI is illustrated. The part for receiving and depacketizing data packets is not illustrated. The network interface NI comprises flow control means including an input queue 44, a remote space register 46, a request generator 45, a routing information register 47, a credit counter 49, a slot table 54, a slot scheduler 55, a header unit 48, a header insertion unit 52 as well as a packet length unit 51 and an output multiplexer 50.

The NI receives the data at its input port 42 from the transmitting processing module IP. The NI outputs the packaged data at its output 43 to the router in form of a data sequence. The data to be transmitted are supplied to the queue 44. The first data in the queue 44 is monitored by the request generator 45. The request generator 45 detects the data and generates a request req_i based on the queue filling and the available remote space as stored in the remote space register 46. The request req_i for the queue is provided to the slot scheduler 55 for selecting the queue. The selection is may be performed by the slot scheduler 55 based on information from the slot table 54 and based on information of the used arbitration mechanism for controlling the set of channels. The scheduler 55 detects whether the data in the queue belongs to a channel a-d having shared slots or belonging to data which are not part of shared channel set slots. As soon as the queue is selected in the scheduler 55 it is provided to a unit 51 which increments the packet lengths and to the header insertion unit 52, which controls whether a header H needs to be inserted or not. Routing information like the addresses is stored in a configurable routing information register 47. The credit counter 49 is incremented when data is consumed in the output queue and is decremented when new headers H are sent with credit value incorporated in the headers H. The routing information from the routing information register 47 as well as the value of the credit counter 49 is forwarded to the header unit 48 and form part of the header H. The header unit 48 receives the credit value and routing info and outputs the header data to the output multiplexer 50. The output multiplexer 50 multiplexes the data provided by the selected queue and the header info hdr provided from the header unit 48. When a data package is sent out the packet length is reset.

As shown in FIG. 5 the request generator detects whether data are filled in one of the queue. The data from the IP are not demultiplexed into multiple queues, but to keep all the data of the channel set in the same queue 44. This automatically implements a

FCFS (first come first serve) policy and reduce the queuing cost significantly. The information that was used to control the de-multiplexer in the conventional architecture must now be queued in parallel to the data queue or in the same queue and increasing the word width of the queue. This control information reflects the channel ID in the channel set and is used to, e.g., select the path of the channel.

A further not illustrated mechanism could be that the scheduler 55 may use a first-come first-serve (FCFS) policy. When this policy is used the order in which the IP writes its data to the NI is queued. The first element in the queue 44 then indicates from which data queue the data may come. Note that the FCFS policy is a bit harder to use when the channel set is made from data coming from multiple IP blocks.

An alternative could be a simple round-robin (RR) scheduler that selects the first queue (the first from the previously selected queue) in the channel set that is non-empty.

One advantage of the method is that latency can be reduced significantly. In the example given, the worst case waiting time for a slot is reduced by a factor of ten. And the higher the ratio of the total bandwidth and the lowest bandwidth of a group of channels initiating from the same NI, the higher the latency reduction gets.

Another advantage is that this scheme does not require that all the channels in the set have both the same source and same destination. All that is required is that the channels have the same source.

Yet another advantage is that this scheme allows to reduce the size of the slot table. The example in this document shows a reduction of a factor of ten.

Yet another advantage is that this scheme allows to reduce the number of queues in the network interface. Referring to this example, one queue needs to be used instead of four.

Previous two advantages reduce the cost of the NI significantly, as the cost of the slot table and queues are dominant in the NI. Moreover, in practical networks it was further found that the cost of the NI dominates.

The only one disadvantage is that the more the channel set diverges, the more the overallocation of slots for the channels is required.

In systems in which the communication of data streams is done via shared memory the application of the invention is very important. In these schemes there are many processing modules writing and reading from a shared memory or multiple memories in general. It is typical of processing modules (CPUs) to have non-blocking writes and blocking reads. And hence the performance of the system depends highly on the latency of the reads. As the reads represents many data streams, all origination from the memory or memory controller the presented invention is very beneficial. Since there are many channels originating from the memory latency is reduced significantly, the slot-table size can be reduced significantly and the queue cost can be reduced significantly.

As all data streams go back and forth to memory, the overallocation is higher as one goes closer to the processing modules. But as all the streaming goes via memory, this overallocation is not a problem at all.

The invention is explained in the context of multiple synchronized TDMA however it is also applicable for single TDMA systems. In general it is applicable to interconnect structures basing on connections and providing guarantees.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage. Furthermore, any reference signs in the claims shall not be construed as limiting the scope of the claims.

1. Integrated circuit comprising a plurality of processing modules (IP) and a network (NoC) arranged for coupling processing modules (IP),
wherein each processing module (IP) includes an associated network interface (NI) which is provided for transmitting data to the network (NoC) and for receiving data from the network (NoC);
wherein data transmission between processing modules (IP) operates based on time division multiple access (TDMA) using time slots (S) and contention free transmission by using channels (a-d); and
wherein each network interface (NI) includes a slot table (ST) for storing an allocation of a time slot to a certain channel (a-d), wherein at least a part of the time slots (0-9) allocated to channels (a-d) originated from the same network interface (NI) are shared for transmission of data of the set of channels (a-d).

2. Integrated circuit as claimed in claim 1, wherein all slots (0-9) allocated to the channels (a-d) are shared and are used in common for data transmission of the set of channels (a-d) from the same network interface (NI).

3. Integrated circuit as claimed in claim 1, including a scheduler (55) included in the network interface (NI), the scheduler (55) is provided for scheduling the data of the set of channels to the shared slots (S).

4. Integrated circuit as claimed in claim 1, wherein data of a channels (a-d) are scheduled by the scheduler (55) depending on the position in a queue (44).

5. Integrated circuit as claimed in claim 1, wherein a scheduling of data of the set of channel is performed depending the filling status of the queue (44) of the set of the channels.

6. Integrated circuit as claimed in claim 1, wherein the data of channels allocated to the set of channels is queued in a single queue (44).

7. Method for allocating time slots for data transmission in an integrated circuit, the integrated circuit having a plurality of processing modules (IP) with a network interface (NI) and a network (NoC), the method comprising the steps of:
communicating between processing modules (IP) based on time division multiple access (TDMA) using time slots and contention free transmission by using channels (a-d);
storing a slot table (ST) in each network interface (NI) including an allocation of a time slot to a certain channel (a-d), and
sharing of time slots (S) allocated to channels originating from the same network interface (NI).

8. Data processing system comprising:
a plurality of processing modules (IP) and a network (NoC) arranged for coupling the processing modules (IP); and
a network interface (NI) associated to each processing module (IP) which is provided for transmitting data to the network (NoC) and for receiving data from the network (NoC);
wherein data transmission between processing modules (IP) operates based on time division multiple access (TDMA) using time slots and contention free transmission by using a channels (a-d);
each network interface (NI) includes a slot table (ST) for storing an allocation of a time slot to a certain channel (a-d); and
a sharing is provided of time slots (S) allocated to channels (a-d) originating from the same network interface (NI).
